(19) United States
(12) Patent Application Publication
(10) Pub. No.: US 2008/0100876 A1
(43) Pub. Date: May 1, 2008

(54) IMAGE PROCESSING APPARATUS AND CONTROL METHOD OF IMAGE PROCESSING APPARATUS

(75) Inventor: Hirokazu Ishii, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/923,170

(22) Filed: Oct. 24, 2007

(30) Foreign Application Priority Data
Oct. 25, 2006 (JP) 2006-290197

(51) Int. Cl. G06K 9/36

(52) U.S. Cl. 358/426.07

(57) ABSTRACT

A coding block of image data to be coded is set with allowing the setting of the coding block to overlap so that an end portion of an image rectangular shape present in the image data is coincident with that of the coding block in code processing, information on thus set coding block is generated, and the coding block is coded. So as to decode the coded data, an overlapped area is deleted from the coded data based on the coding block information and the coded data. Thereby, image quality deterioration generated at not only an end portion of the image data but also the end portion of the image rectangular shape present in the image data can be reduced.

### BACKGROUND OF THE INVENTION

1. Field of the Invention

The present invention relates to an image processing apparatus which includes a coding device and a decoding device and in which the decoding device decodes coded data based on the coded data supplied from the coding device, and also relates to a control method of the image processing apparatus.

2. Description of the Related Art

Heretofore, in a case where data stored in a host terminal or the like is printed with a printer, the host terminal converts the data into a data format which can be subjected to printer processing, and transmits this converted data to a printer, and the printer rearranges data rows and converts resolution if necessary, before printing the data.

In this case, examples of processing to be performed by the host terminal include color space conversion processing and quantization processing, and the processing performed by the host terminal generally differs according to print settings such as a type of a sheet, a printing quality level and the like, respectively.

However, in recent years, with high performance and high function of the printer, the printer can execute the color space conversion processing, the quantization processing and the like.

Therefore, a system is also present in which a host terminal executes only code processing of data, and transmits the coded data to a printer and in which the printer executes decode processing, color space conversion processing, quantization processing, resolution conversion processing and the like to print the data.

In this case, when the host terminal performs the code processing, a joint photographic experts group (JPEG) is sometimes used as a coding system. This JPEG is a general data format which broadly spreads as a recording system of a digital camera or the like, and has a high compression ratio, so that a size of data to be transferred can be reduced. Furthermore, in some printers, to realize a photocopying function, a JPEG decoder of hardware is mounted, so the JPEG can be decoded at a high speed.

In this JPEG, attention is paid to a human visual characteristic that people are not sensitive to high-frequency components. After an image signal is converted from a space area to a frequency area, the high-frequency components are reduced to realize high compression. It is to be noted that the conversion processing into the frequency area is performed for a block unit referred to as an MCU (minimum coded unit).

A system is known in which image quality deterioration is reduced in a case where the code processing is performed for such a block unit (e.g., see Japanese Patent Application Laid-Open Nos. 2000-69293 and 2003-289440).

In Japanese Patent Application Laid-Open No. 2000-69293, a system is described in which when image data in a block runs short at an end portion of the image data during the code processing performed for a block unit, the end of the image data is repeatedly used to reduce the image quality deterioration at the end portion of the image data.

In Japanese Patent Application Laid-Open No. 2003-289440, a system is described in which when image data in a block runs short at an end portion of the image data during the code processing performed for a block unit, the image quality deterioration at the end portion of the image data is reduced using data that is present outside the image data.

However, in the above-mentioned invention of Japanese Patent Application Laid-Open No. 2000-69293, the image quality deterioration at the end portion of the image data can be reduced, but there is a problem that the image quality deterioration generated at an end portion of an image rectangular shape present in the image data cannot be reduced.

That is, when a block including a plurality of image rectangular shapes that are not correlated with one another is converted into the frequency area, this block is provided with the high-frequency components, and there is resultantly a problem that the image quality deteriorates in the code processing to reduce the high-frequency components.

Moreover, in the invention described in Japanese Patent Application Laid-Open No. 2003-289440, there is a problem that the image quality deterioration generated at the end portion of the image rectangular shape present in the image data cannot be reduced in the same manner as in Japanese Patent Application Laid-Open No. 2000-69293. Furthermore, in a case where there is not any effective data outside the image data, the image quality deterioration at the end portion of the image data cannot be reduced.

### SUMMARY OF THE INVENTION

An object of the present invention is to provide an image processing apparatus in which image quality deterioration generated at not only an end portion of image data but also an end portion of an image rectangular shape present in the image data can be reduced, and a control method of the image processing apparatus.

Moreover, an object of the present invention is to provide an image processing apparatus in which a coding block is moved and coded so that image quality is not deteriorated during the coding and in which an overlapped area can be deleted to decode the coded data during the decoding, and a control method of the image processing apparatus.

Furthermore, the present invention has coding block setting means for setting a coding block so that an end portion of an image rectangular shape present in image data input via image data input means is coincident with that of the coding block in code processing. The present invention has coding block information generating means for generating information on the coding block set by the coding block setting means, and coding means for coding the coding block set by the coding block setting means. Furthermore, an object of the present invention is to provide an image processing apparatus having decoding means for deleting an overlapped area from coded data based on the coding block information and the coded data coded by the coding means, to decode the coded data.

Further features of the present invention will become apparent from the following description of exemplary embodiments with reference to the attached drawings.

### BRIEF DESCRIPTION OF THE DRAWINGS

FIG. 1 is a block diagram showing a constitution of a host terminal 100 in an image processing system according to Embodiment 1 of the present invention.

FIG. 2 is a block diagram showing a constitution of a printer 200 in the image processing system according to Embodiment 1.

FIG. 3 is a flow chart showing code processing to be executed by a printer driver program 109 of the host terminal 100.

FIG. 4 is a flow chart showing coding block set processing (S302).

FIG. 5 is an explanatory view of coding block reset processing performed in S407, and is a diagram showing a state in which a certain area is cut out of image data.

FIG. 6 is an explanatory view of the coding block reset processing performed in S407, and is a diagram showing a state in which a certain area is cut out of the image data.

FIG. 7 is a diagram showing a data structure of overlapped area information 700 generated in S408.

FIG. 8 is a diagram showing a specific example of the overlapped area information 700.

FIG. 9 is a flow chart showing printing data control performed by the printer driver program 109 of the host terminal 100.

FIG. 10 is a diagram showing a command format in a case where print setting information, the overlapped area information 700 and JPEG data are transferred to the printer 200.

FIG. 11 is a flow chart showing decode processing performed by the printer 200.

FIG. 12 is a diagram showing coded data obtained by coding the area shown in FIG. 5.

FIG. 13 is a flow chart showing printing data control performed by an image processing program 212 of the printer 200.

FIG. 14 is a flow chart showing code processing performed by a printer driver program 109 of a host terminal 100 in Embodiment 2.

FIG. 15 is a flow chart showing the printing data control executed by the printer driver program 109 of the host terminal 100.

FIG. 16 is a flow chart showing decode processing performed by the printer 200.

FIG. 17 is a flow chart showing printing data control executed by the image processing program 212 of the printer 200.

### DESCRIPTION OF THE EMBODIMENTS

An exemplary embodiment of the present invention will hereinafter be described.

### Embodiment 1

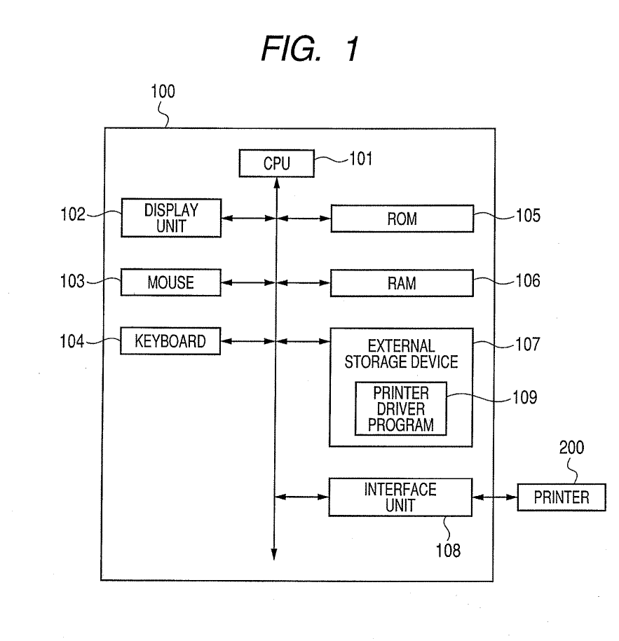

FIG. 1 is a block diagram showing a constitution of a host terminal 100 in an image processing system according to Embodiment 1 of the present invention.

The host terminal 100 is an example of an image processing apparatus, and has a CPU 101, a display unit 102, a mouse 103 as operation instruction input means, a keyboard 104, a ROM 105, a RAM 106, and an external storage device 107. The host terminal 100 also has an interface unit 108, and is connected to a printer 200.

The external storage device 107 includes a hard disk and a flash ROM, and stores a printer driver program 109 which generates printing data and controls the printer 200.

It is to be noted that if any external storage device is not disposed, the printer driver program 109 may be stored in the ROM 105.

The printer driver program 109 performs JPEG code processing by use of DCT conversion as one of orthogonal conversion systems, quantization, Huffman coding and the like, and transfers coded data and additional information as printing data to the printer 200. It is to be noted that the code processing is performed for a block unit of eight lines×eight pixels, which is referred to as MCU (minimum coded unit).

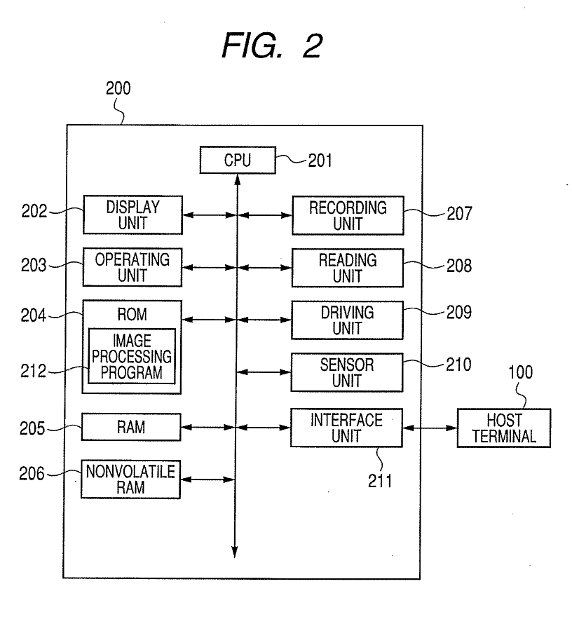

FIG. 2 is a block diagram showing a constitution of the printer 200 in the image processing system according to Embodiment 1.

The printer 200 has a CPU 201, a display unit 202, an operating unit 203 as operation instruction input means, a ROM 204, a RAM 205, a nonvolatile RAM 206, a recording unit 207, a reading unit 208, a driving unit 209, and a sensor unit 210. The printer 200 has an interface unit 211, and is connected to the host terminal 100 via the interface unit 211.

The ROM 204 stores an image processing program 212 which performs decode processing for decoding coded printing data, color space conversion, quantization processing and the like.

The image processing program 212 decodes JPEG coded printing data, and decodes image data by use of Huffman decoding, reverse quantization, reverse DCT conversion and the like for a block unit including a plurality of pixels. This decoded image data is subjected to the color space conversion and conversion processing such as quantization processing, and this converted printing data is supplied to the recording unit 207.

The nonvolatile RAM 206 is an SRAM or the like backed up with a battery, and stores data or the like inherent in the image recording apparatus 200. The recording unit 207 executes a recording operation, when the printing data generated by the image processing program 212 reaches a predetermined amount required for performing the recording operation. The reading unit 208 reads a draft image, and outputs luminance data of red (R), green (G) and blue (B) colors.

The driving unit 209 includes a stepping motor for driving sheet supply and discharge rollers in operations of the recording unit 207 and the reading unit 208, respectively, a driver circuit which controls a gear to transmit a driving power of the stepping motor and the stepping motor and the like.

The sensor unit 210 includes a recording sheet width sensor (for sensing the presence/absence of the recording sheet), a recording sheet sensor, an original width sensor, an original sensor (for sensing the presence/absence of an original), a recording medium detection sensor and the like. The CPU 201 detects states of the original and the recording sheet based on information output from the sensor unit 210.

Next, the code processing to be executed by the printer driver program 109 of the host terminal 100 will be described.

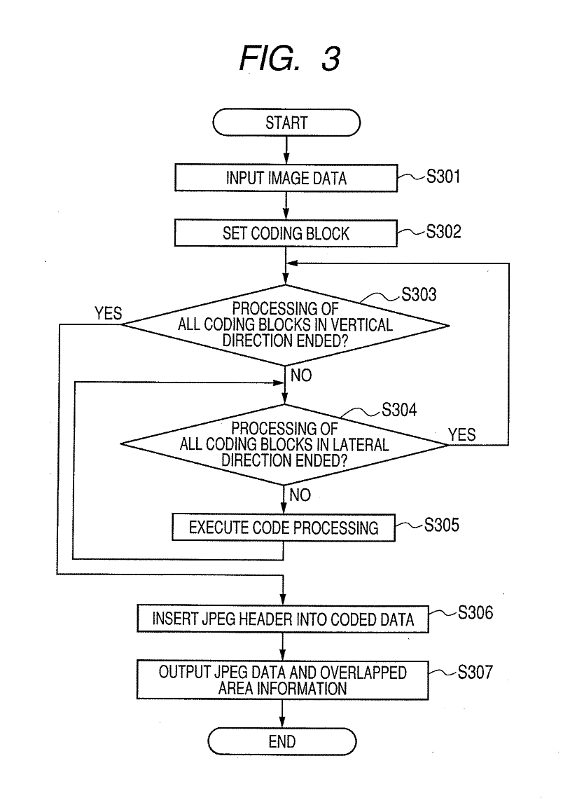

FIG. 3 is a flow chart showing the code processing to be executed by the printer driver program 109 of the host terminal 100.

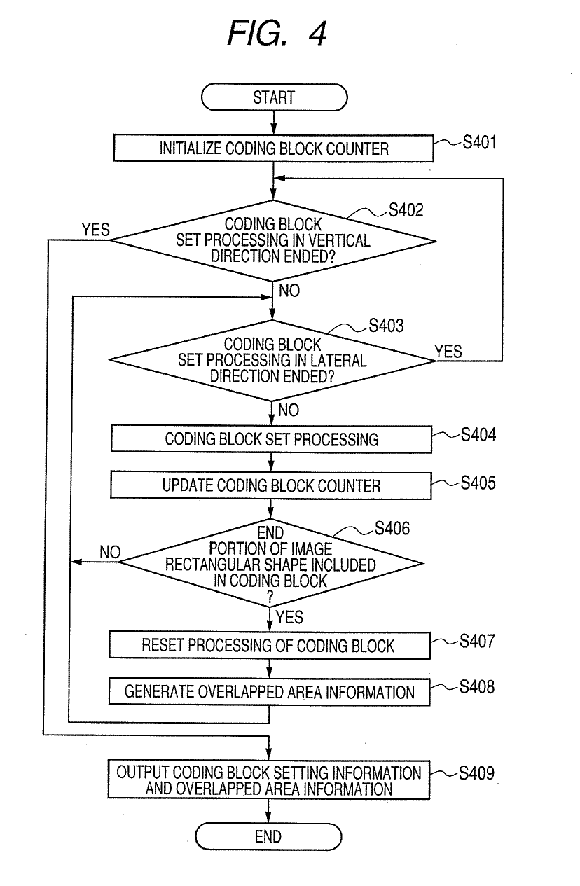

First, in S301, the image data is supplied to a code processing section of the printer driver program 109. In S302, the image data is subjected to coding block set processing in order to code the image data. It is to be noted that this coding block set processing will be described later with reference to FIG. 4. It is judged in S303 whether or not the code processing of all coding blocks in a vertical direction, which have been set in S302, has ended. In a case where it is judged in S303 that the code processing of all the coding blocks in the vertical direction has ended, the processing advances to S306.

On the other hand, in a case where it is judged in S303 that the code processing of all the coding blocks in the vertical direction has not ended, the processing advances to S304. It is judged in S304 whether or not the code processing of all the coding blocks in a lateral direction, which have been set in S302, has ended. In a case where it is judged in S304 that the code processing of all the coding blocks in the lateral direction has ended, the processing returns to S303.

In a case where it is judged in S304 that the code processing of all the coding blocks in the lateral direction has not ended, the processing advances to S305. In S305, the coding block is subjected to DCT conversion, quantization processing and Huffman coding to execute the code processing, and the processing returns to S304.

When the processing of S303 to S305 is repeated and the code processing of all the coding blocks ends, the processing advances to S306. In S306, JPEG header data is inserted into the top of the coded data generated in S305 to form the coded data of the JPEG format.

This header data includes data required for JPEG decode processing, for example, Huffman table used during the Huffman coding, a quantization table used during the quantization processing and the like.

Finally in S307, JPEG data and overlapped area information 700 described later are output, thereby ending the processing.

FIG. 4 is a flow chart showing the coding block set processing (S302).

It is to be noted that the coding block includes eight lines×eight pixels, and is set rightwards in order from an upper left end of the image data. When the setting in the lateral direction ends, the setting moves downwards to set the block rightwards in order from a left end. Finally, the block is set at a lower right end of the image data.

First, in S401, “1” is set to a coding block counter. Thus, “1” is set to the coding block counter so as to manage an ordinal number of the coding block set with respect to the image data, which coding block is being processed.

It is judged in S402 whether or not the set processing of all the coding blocks in the vertical direction with respect to the image data has ended. In a case where it is judged in S402 that the setting of all the coding blocks in the vertical direction has ended, the processing advances to S409.

On the other hand, in a case it is judged in S402 that the setting of all the coding blocks in the vertical direction has not ended, the processing advances to S403. It is judged in S403 whether or not the setting of all the coding blocks in the lateral direction with respect to the image data has ended. In a case where it is judged in S403 that the setting of all the coding blocks in the lateral direction has ended, the processing returns to S402.

On the other hand, in a case where it is judged in S403 that the setting of all the coding blocks in the lateral direction has not ended, the processing advances to S404. In S404, a coding block of eight lines×eight pixels is set with respect to an area where any coding block is not set. In S405, 1 is added to a value of the coding block counter.

It is judged in S406 whether or not the end portion of the image rectangular shape is included in the coding block set in S404. That is, it is judged whether or not the coding block includes a plurality of image rectangular shapes.

In a case where it is judged in S406 that the end portion of the image rectangular shape is not included, that is, it is judged that the coding block includes a single image rectangular shape, the processing returns to S403.

On the other hand, in a case where it is judged in S406 that the end portion of the image rectangular shape is included, that is, it is judged that the coding block includes a plurality of image rectangular shapes, the processing advances to S407. In S407, the coding block is reset (or set again) so that an end portion of the coding block is coincident with that of the image rectangular shape. At this time, the coding block is moved (a coding target pixel of the coding block is changed) leftwards or upwards until the end portion of the coding block is coincident with that of the image rectangular shape, and the coding block is reset so as to include the already set area.

That is, the coding block needs to be set with respect to all the pixels constituting the image data. When the coding block is moved rightwards or downwards, an area where any coding block is not set is generated. Therefore, the coding block is moved leftwards or upwards so as to include this area, and the coding block is reset.

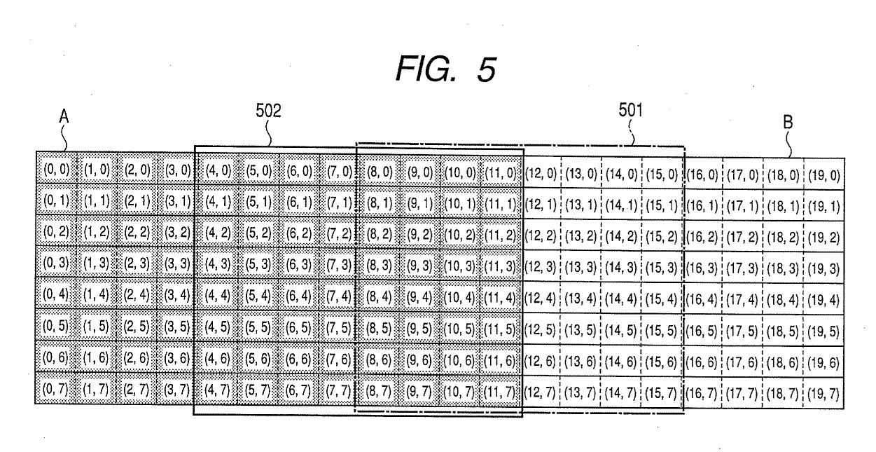

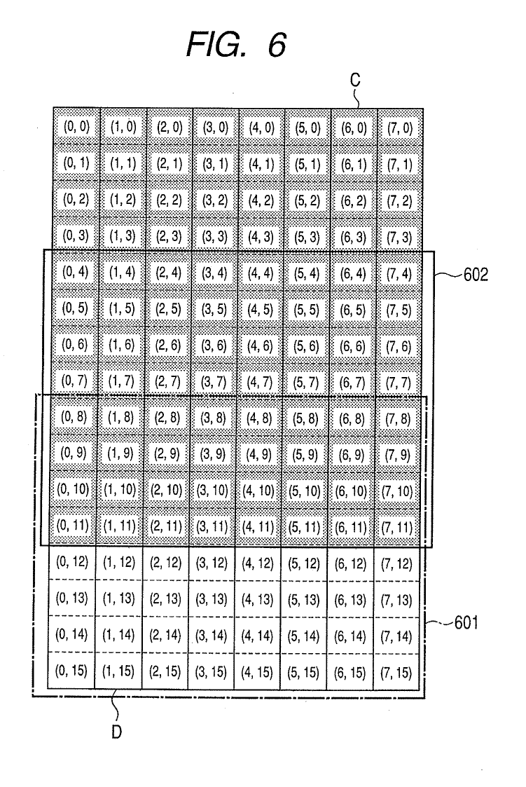

It is to be noted that the resetting (or set-again) of the coding block will be described later with reference to FIGS. 5, 6.

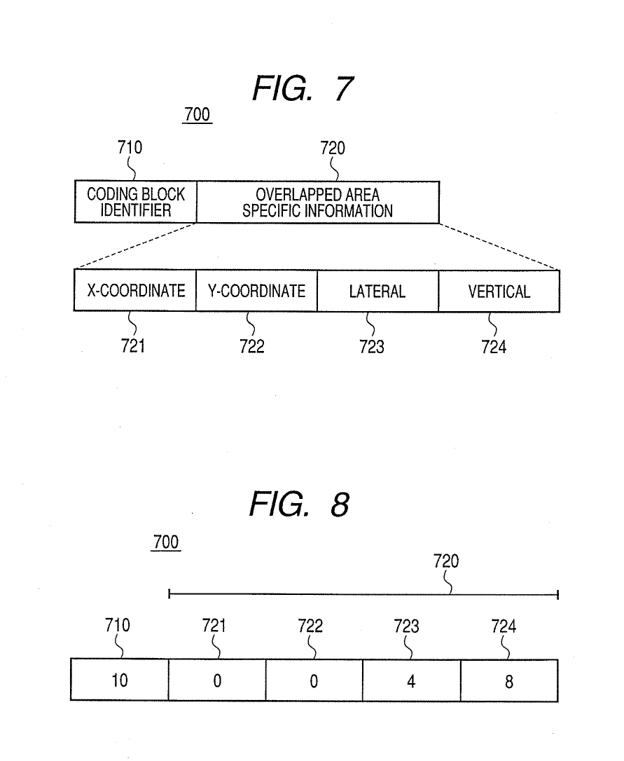

In S408, the overlapped area information 700 is generated. The overlapped area information 700 will be described with reference to FIG. 7.

When the processing of S402 to S408 is repeated and the coding block set processing ends with respect to all areas, in S409, the coding block setting information and the overlapped area information 700 are output to end the processing.

FIG. 5 is an explanatory view of the coding block reset processing performed in S407, and is a diagram showing a state in which a certain area is cut out of the image data.

It is assumed that the coding blocks are already set to upper and left areas which come in contact with an area shown in FIG. 5.

The area shown in FIG. 5 includes an image rectangular shape A surrounded with pixels (0, 0), (11, 0), (0, 7) and (11, 7) and an image rectangular shape B surrounded with pixels (12, 0), (19, 0), (12, 7) and (19, 7). The image rectangular shape A is, for example, an image of a character and a line of black or another color, and is an image other than a background portion such as a all white image. The rectangular area B is, for example, a background portion such as the all white image, or a background portion of light color.

First, the coding block is set with respect to an area surrounded with pixels (0, 0), (7, 0), (0, 7) and (7, 7). Since this coding block includes only data of the image rectangular shape A, the coding block is not reset.

Subsequently, the coding block is set to an area 501 surrounded with pixels (8, 0), (15, 0), (8, 7) and (15, 7). Since this coding block 501 includes data of the image rectangular shape A and data of the image rectangular shape B, the coding block is reset. That is, the coding block is moved (the pixels as the coding target of the coding block are changed). That is, the coding block 501 is moved by four pixels leftwards so that the end portion of the coding block is coincident with that of the image rectangular shape A.

In consequence, the coding block is reset to an area 502 surrounded with pixels (4, 0), (11, 0), (4, 7) and (11, 7).

Finally, the coding block is set to an area where any coding block is not set, that is, an area surrounded with (12, 0), (19, 0), (12, 7) and (19, 7). Since this coding block includes the only data of the image rectangular shape B, the coding block does not have to be reset.

FIG. 6 is an explanatory view of the coding block reset processing performed in S407, and is a diagram showing a state in which a certain area is cut out of the image data.

It is assumed that the coding blocks have already been set to the area surrounded with the pixels (0, 0), (7, 0), (0, 7) and (7, 7) and a left area which comes in contact with this area.

Moreover, this area includes an image rectangular shape C surrounded with the pixels (0, 0), (7, 0), (0, 11) and (7, 11) and an image rectangular shape D surrounded with the pixels (0, 12), (7, 12), (0, 15) and (7, 15). The image rectangular shape C is, for example, an image of a character or a line of black or another color, and is an image other than a background portion such as a all white image. The rectangular area D is the background portion of the all white image or light color.

First, a coding block is set to an area 601 surrounded with pixels (0, 8), (7, 8), (0, 15) and (7, 15).

Since this coding block 601 includes data of the image rectangular shapes C and D, the coding block is reset. That is, the coding block is moved as much as four pixels upwards (the setting target of the coding block is changed as much as four pixels upwards so that an end portion of the coding block is coincident with that of the image rectangular shape C.

In consequence, the coding block is reset to an area 602 surrounded with pixels (0, 4), (7, 4), (0, 11) and (7, 11). It is to be noted that the coding block is set to an area surrounded with pixels (0, 12), (7, 12), (0, 15) and (7, 15) in the next coding block set processing in the lateral direction.

FIG. 7 is a diagram showing a data structure of the overlapped area information 700 generated in S408.

The overlapped area information 700 has a coding block identifier 710 and overlapped area specific information 720. The coding block identifier 710 is an identifier which identifies the coding block in which an overlapped area (an area where the setting of coding block is overlapped) is a target of the coding.

The coding block identifier 710 sets 1 to the coding block at an upper left end of the image data, and sets 2 to an identifier of the subsequently set coding block. In this manner, 1 is added every time the coding block is set. That is, the coding block counter executes the addition.

The overlapped area specific information 720 is stored after this coding block identifier 710. The overlapped area specific information 720 includes an overlapped area start X-coordinate 721, an overlapped area start Y-coordinate 722, an overlapped area lateral pixel number 723, and an overlapped area vertical pixel number 724. It is to be noted that the pixel at an upper left end of the coding block is set to (X, Y)=(0, 0).

FIG. 8 is a diagram showing a specific example of the overlapped area information 700.

In a case where the coding block in which the overlapped area (the area where the setting of coding block is overlapped) is the target of the coding in the image data is the tenth set coding block, “10” is stored in the coding block identifier 710.

Moreover, 0 is stored as the overlapped area start X-coordinate value 721 and the Y-coordinate value 722, respectively, 4 is stored as the overlapped area lateral pixel number 723, and 8 is stored as the vertical pixel number 724.

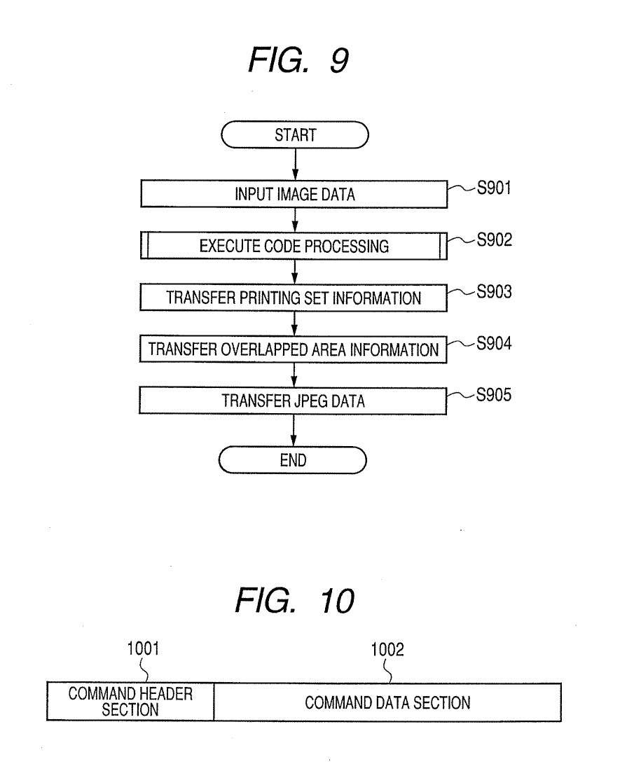

FIG. 9 is a flow chart showing printing data control performed by the printer driver program 109 of the host terminal 100.

First, in S901, the image data as a printing target is supplied to the printer driver program 109 from an operating system or application program (not shown) operated at the host terminal 100.

In S902, the image data code processing shown in FIG. 3 is executed. As a result of the performed code processing, the JPEG data and the overlapped area information 700 are generated.

In S903, print setting information designated from the operating system or the application program is transferred to the printer 200 via the interface unit 108. This print setting information is, for example, information on a printing sheet, a printing quality level or the like.

In S904, the overlapped area information 700 is transferred to the printer 200 via the interface unit 108. The overlapped area information 700 is information which specifies the overlapped area, and specifically has a coding block identifier, an overlapped area start X-coordinate in the coding block, an overlapped area start Y-coordinate in the coding block, an overlapped area lateral pixel number, and an overlapped area vertical pixel number. In S905, the JPEG data is transferred to the printer 200 via the interface unit 108, thereby ending the processing.

FIG. 10 is a diagram showing a command format in a case where the print setting information, the overlapped area information 700 and the JPEG data are transferred to the printer 200.

A command to be transferred to the printer 200 includes a command header portion 1001 and a command data portion 1002.

In the command header portion 1001, there are stored an identifier which identifies a type of data (the print setting information, the overlapped area information 700 or the JPEG data) stored in the command data portion 1002, a size of data and the like.

In the command data portion 1002, the print setting information, the overlapped area information 700 or the JPEG data are stored in accordance with a type of a command header.

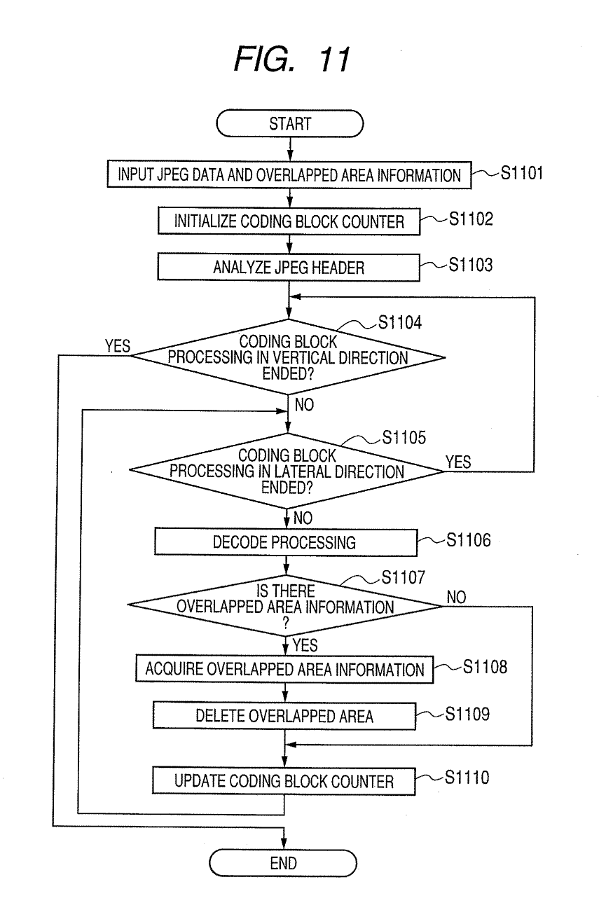

FIG. 11 is a flow chart showing decode processing performed by the printer 200.

In S1101, the JPEG data and the overlapped area information 700 are supplied to the decode processing section of the image processing program 212 via the interface unit 211 of the printer 200.

In S1102, “1” is set to the coding block counter. This “coding block counter” is a counter which manages the ordinal number of the coding block in the JPEG data, which coding block is being processed.

Since the decode processing is performed in order of storage of the coding block, the overlapped area information 700 can be searched using the coding block counter.

In S1103, a header of the JPEG data is analyzed. This “JPEG header” includes information necessary for decoding.

It is judged in S1104 whether or not the decode processing of all the coding blocks in the vertical direction has ended. In a case where it is judged in S1104 that the decode processing of all the coding blocks in the vertical direction has ended, the processing ends.

On the other hand, in a case where it is judged in S1104 that the decode processing of all the coding blocks in the vertical direction has not ended, it is judged in S1105 whether or not the decode processing of all the coding blocks in the lateral direction has ended. In a case where it is judged in S1105 that the decode processing of all the coding blocks in the lateral direction has ended, the processing returns to S1104.

On the other hand, in a case where it is judged in S1105 that the decode processing of all the coding blocks in the lateral direction has not ended, in S1106, decode processing such as Huffman decoding, reverse quantization and reverse DCT conversion is executed to advance to S1107.

It is judged in S1107 whether or not the overlapped area information 700 for the presently processed coding block is present. That is, the coding block identifier matched with the present coding block counter is searched to search the overlapped area information 700.

In a case where it is judged in S1107 that the overlapped area information 700 is not present, the processing advances to S1110.

On the other hand, in a case where it is judged in S1107 that the overlapped area information 700 is present, the overlapped area information 700 is acquired in S1108. The overlapped area information 700 to be acquired is “overlapped area information on the presently processed coding block” searched in S1107.

In S1109, the overlapped area is deleted from data in which the coding block is decoded, based on the overlapped area information 700 acquired in S1108.

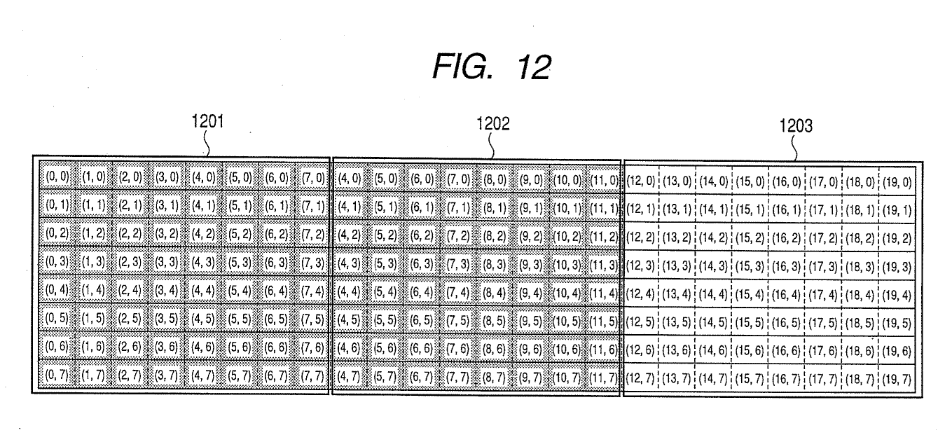

The deletion of the overlapped area will be described later with reference to FIG. 12.

Finally in S1110, 1 is added to the value of the coding block counter.

When the processing of S1104 to S1110 is repeated and the decode processing of all the coding blocks ends, the processing ends.

Next, overlapped area deletion processing performed in S1109 will be described.

FIG. 12 is a diagram showing coded data obtained by coding the area shown in FIG. 5.

First, a coding block 1201 is decoded. Since any overlapped area is not set to this coding block 1201, all data is output.

Subsequently, a coding block 1202 is decoded. Since the overlapped area information 700 shown in FIG. 8 is set to this coding block 1202, the coded data corresponding to the overlapped area is deleted in accordance with this set overlapped area information 700.

That is, in the overlapped area information 700, “0” is stored as the overlapped area start X-coordinate value in the coding block, and “0” is stored as the overlapped area start Y-coordinate value in the coding block. Moreover, “4” is stored as the overlapped area lateral pixel number, and “8” is stored as the overlapped area vertical pixel number.

Therefore, in the coding block 1202, a coordinate of overlapped area start in the coding block is (0, 0) as an upper left pixel position in the coding block, and the overlapped area includes four lateral pixels and eight vertical pixels. Since this area is surrounded with pixels (4, 0), (7, 0), (4, 7) and (7, 7) in the coding block 1202 of FIG. 12, this area is deleted, and only data of an area surrounded with pixels (8, 0), (11, 0), (8, 7) and (11, 7) is output.

Finally, a coding block 1203 is decoded. Since any overlapped area is not set to this coding block 1203, all data is output.

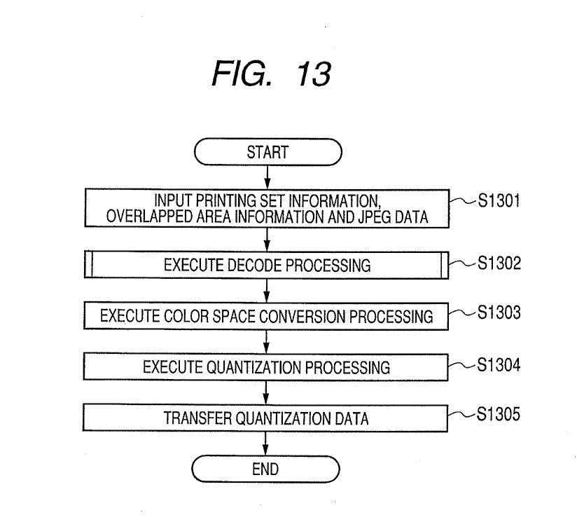

FIG. 13 is a flow chart showing printing data control performed by the image processing program 212 of the printer 200.

First, in S1301, the print setting information, the overlapped area information 700 and the JPEG data are input into the image processing program 212. In S1302, the decode processing of the JPEG data shown in FIG. 11 is executed. In S1303, the data decoded based on the print setting information is subjected to color space conversion processing.

In S1304, the quantization processing is executed based on the print setting information. Finally in S1305, the quantization data is transferred to the recording unit 207, thereby ending the processing.

In Embodiment 1, during coding, the coding block is moved to perform the coding so that the image quality does not deteriorate. During decoding, since decode processing is performed in consideration of the movement of the coding block, image quality deterioration at the end portion of the image data can be reduced.

Moreover, according to Embodiment 1, the image quality deterioration generated at the end portion of the image rectangular shape present in the image data can be reduced.

### Embodiment 2

Next, Embodiment 2 of the present invention will be described.

Embodiment 2 is an embodiment in which overlapped area information 700 is stored in an application data segment or a comment segment of a JPEG header.

In Embodiment 2, since a block diagram showing a constitution of a host terminal 100 and a block diagram showing a constitution of a printer 200 are similar to those of Embodiment 1, description thereof is omitted.

Moreover, since coding block set processing according to Embodiment 2 is similar to that of Embodiment 1, FIG. 4 is hereby incorporated by reference herein and description thereof is omitted.

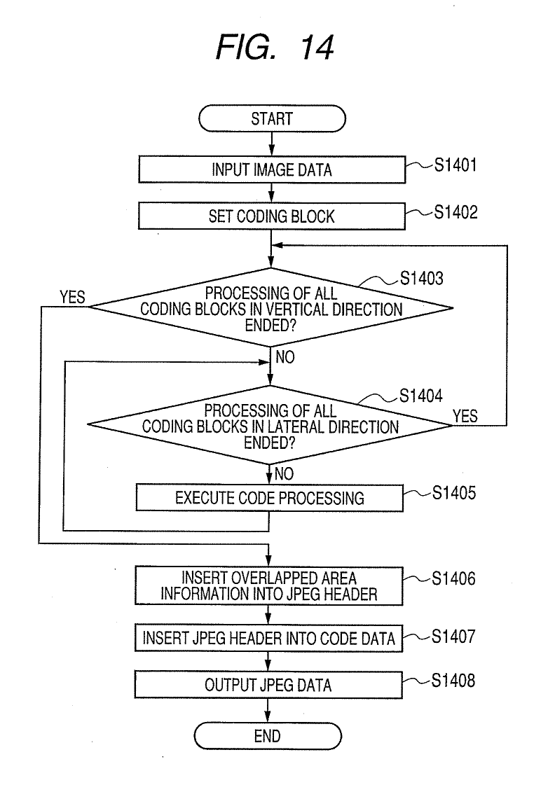

FIG. 14 is a flow chart showing code processing performed by a printer driver program 109 of a host terminal 100 in Embodiment 2.

First, in S1401, image data is supplied to a code processing section of the printer driver program 109. In S1402, the image data is subjected to coding block set processing in order to code the image data.

It is judged in S1403 whether or not the code processing of all coding blocks in a vertical direction, which have been set in S1402, has ended. In a case where it is judged in S1403 that the code processing of all the coding blocks in the vertical direction has not ended, it is judged in S1404 whether or not the code processing of all the coding blocks in a lateral direction, which have been set in S1402, has ended. In a case where it is judged in S1404 that the code processing of all the coding blocks in the lateral direction has ended, the processing returns to S1403.

On the other hand, in a case where it is judged in S1404 that the code processing of all the coding blocks in the lateral direction has not ended, in S14051, the coding block is subjected to DCT conversion, quantization processing and Huffman processing to execute the code processing, thereby returning to S1404.

When the processing of S1403 to S1405 is repeated and the code processing of all the coding blocks ends, the overlapped area information 700 is stored in the application data segment or the comment segment of the JPEG header. The application data segment and the comment segment are areas in which information inherent in application can freely be stored.

In S1407, JPEG header data is inserted into the top of all the coded data generated in S1405 to form the coded data of a JPEG format. The JPEG header data includes data required for JPEG decode processing, for example, Huffman table used during the Huffman coding, a quantization table used during the quantization processing and the like. The JPEG header data also includes the overlapped area information 700 stored in S1406.

Finally, in S1408, the JPEG data is output to end the processing.

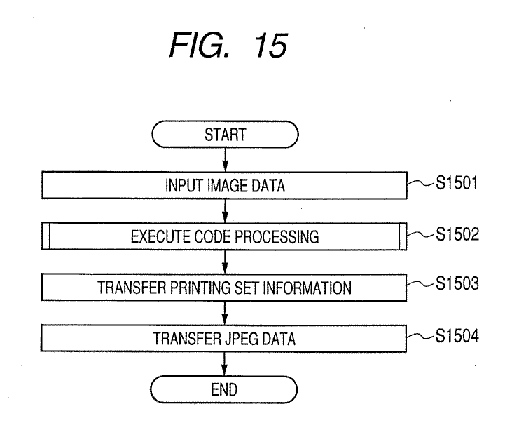

FIG. 15 is a flow chart showing the printing data control executed by the printer driver program 109 of the host terminal 100.

First, in S1501, image data as a printing target is supplied to the printer driver program 109 from an operating system or application program (not shown) operated at the host terminal 100. In S1502, the image data code processing shown in FIG. 3 is executed. As a result of the performed code processing, the JPEG data is generated.

In S1503, print setting information designated from the operating system or application program is transferred to the printer 200 via the interface unit 108. As the print setting information, for example, information on a printing sheet, a printing quality level or the like is transferred.

Finally in S1504, the JPEG data is transferred to the printer 200 via the interface unit 108 to end the processing. At this time, even the overlapped area information 700 stored in the header of the JPEG header is transferred.

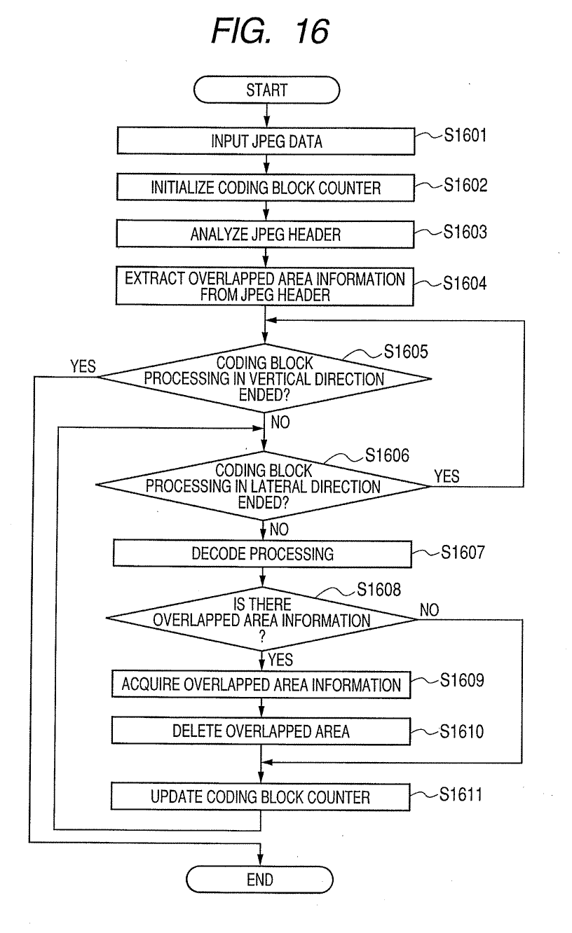

FIG. 16 is a flow chart showing decode processing performed by the printer 200.

In S1601, the JPEG data is supplied to a decode processing section of an image processing program 212 via an interface unit 211 of the printer 200.

In S1602, “1” is set to a coding block counter. That is, “1” is set to the coding block counter in order to manage that the coding block which is being processed is the first coding block in the JPEG data.

Since the decode processing is performed in order of storage of the coding block, the overlapped area information 700 can be searched based on this value of the coding block counter.

In S1603, the header of the JPEG data is analyzed, and information required for the decoding is included in this JPEG header. In S1604, the overlapped area information 700 is extracted from the JPEG header analyzed in S1603. It is to be noted that the overlapped area information 700 is stored in the comment segment or the application data segment.

It is judged in S1605 whether or not the decode processing of all the coding blocks in the vertical direction has ended. In a case where it is judged in S1605 that the decode processing of all the coding blocks in the vertical direction has ended, the processing ends.

On the other hand, in a case where it is judged in S1605 that the decode processing of all the coding blocks in the vertical direction has not ended, it is judged in S1606 whether or not the decode processing of all the coding blocks in the lateral direction has ended. In a case where it is judged in S1606 that the decode processing of all the coding blocks in the lateral direction has ended, the processing returns to S1605.

On the other hand, in a case where it is judged in S1606 that the decode processing of all the coding blocks in the lateral direction has not ended, in S1607, decode processing such as Huffman decoding, reverse quantization and reverse DCT conversion is executed to advance to S1608. It is judged in S1608 whether or not the overlapped area information 700 on the presently processed coding block is present. That is, the overlapped area information 700 is searched to check whether or not a coding block identifier matched with the present coding block counter is present.

In a case where it is judged in S1608 that the overlapped area information 700 is not present, the processing advances to S1611.

On the other hand, in a case where it is judged in S1608 that the overlapped area information 700 is present, the overlapped area information 700 is acquired in S1609. The overlapped area information 700 to be acquired is information searched in S1608.

In S1610, the overlapped area is deleted from data in which the coding block is decoded, based on the overlapped area information 700 acquired in S1609.

Finally in S1611, 1 is added to the value of the coding block counter.

When the processing of S1605 to S1611 is repeated and the decode processing of all the coding blocks ends, the processing ends.

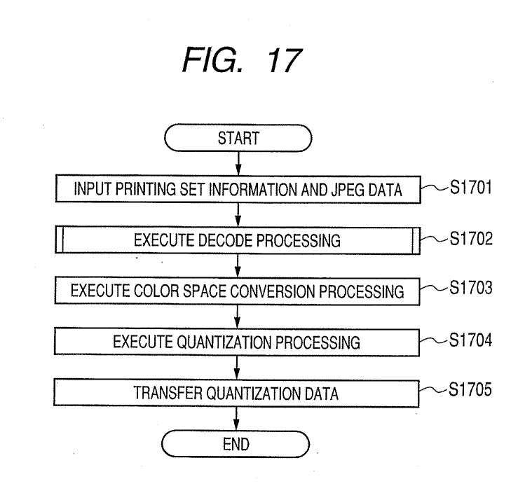

FIG. 17 is a flow chart showing printing data control executed by the image processing program 212 of the printer 200.

First, in S1701, the print setting information and the JPEG data are input into the image processing program 212. The overlapped area information 700 is stored in the header of this JPEG data. In S1702, the decode processing of the JPEG data shown in FIG. 16 is executed.

In S1703, the data decoded based on the print setting information is subjected to color space conversion processing. In S1704, the quantization processing is executed based on the print setting information.

Finally in S1705, the quantized data is transferred to a recording unit 207 to end the processing.

It is to be noted that in Embodiments 1 and 2, the code processing and the decode processing are executed in different apparatuses, but the code processing and the decode processing may be operated in the same apparatus. For example, the above embodiment may be applied to a system in which during reading in a photocopying machine, draft data is subjected to code processing and stored in an internal memory, and during recording, coded data in the internal memory is subjected to the decode processing to perform printing.

According to the above embodiment, since the code processing section and the decode processing section are cooperated, the image quality deterioration generated at not only the end portion of the image data but also the end portion of the image rectangular shape present in the image data can be reduced. That is, according to the embodiments, during the coding, the coding block is moved and coded so that the image quality does not deteriorate, and during the decoding, the overlapped area is deleted to decode the encoded data. Therefore, the image quality deterioration of the end portion of the image data can be reduced.

Moreover, according to the embodiments, since any special code processing device or decode processing device does not have to be prepared in order to reduce the image quality deterioration at the image data or the end portion of the image rectangular shape present in the image data, the system can easily and inexpensively be constructed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2006-290197, filed Oct. 25, 2006, which is hereby incorporated by reference herein in its entirety.

What is claimed is:

1. An image processing apparatus which performs coding and decoding, comprising;
an image data input unit which inputs image data;
a coding block setting unit which sets a coding block, with allowing the setting of coding block to overlap so that an end portion of an image rectangular shape present in the image data input via the image data input unit is coincident with that of the coding block in code processing;
a coding block information generating unit which generates information on the coding block set by the coding block setting unit;
a coding unit which codes the coding block set by the coding block setting unit; and
a decoding unit which deletes an overlapped area from coded data based on the coding block information and the coded data coded by the coding unit, to decode the coded data.

2. The image processing apparatus according to claim 1, wherein the coding block is a coding block including a plurality of pixels.

3. The image processing apparatus according to claim 1, wherein the coding block information is information including a coding block identifier and overlapped area information.

4. The image processing apparatus according to claim 1, wherein the coded data is data coded into a JPEG format.

5. A control method of an image processing apparatus which performs coding and decoding, the method of:
inputting image data;
setting the coding block, with allowing the setting of coding block to overlap so that an end portion of an image rectangular shape present in the image data input via an image data input unit is coincident with that of the coding block in code processing;
generating information on the coding block set in the coding block setting process;
coding the coding block set in the coding block setting process; and
deleting an overlapped area from coded data, based on the coding block information and the coded data coded in the coding process, to decode the coded data.

6. A printing system comprising:
an image processing apparatus including an image data input unit which inputs image data, a coding block setting unit which sets the coding block, with allowing the setting of coding block to overlap so that an end portion of an image rectangular shape present in the image data input via the image data input unit is coincident with that of the coding block in code processing, a coding block information generating unit which generates information on the coding block set by the coding block setting unit, a coding unit which codes the coding block set by the coding block setting unit, and a decoding unit which deletes an overlapped area from coded data, based on the coding block information and the coded data coded by the coding unit, to decode the coded data; and
a printing unit.
